(19) United States
(12) Patent Application Publication
(10) Pub. No.: US 2019/0000068 A1
(43) Pub. Date: Jan. 3, 2019

(54) WIRE BRISTLE PEST CONTROL APPARATUS

(71) Applicant: Lamar Williams, Stockbridge, GA (US)

(72) Inventor: Lamar Williams, Stockbridge, GA (US)

(21) Appl. No.: 16/020,330

(22) Filed: Jun. 27, 2018

Related U.S. Application Data
(60) Provisional application No. 62/525,840, filed on Jun. 28, 2017.

(51) Int. Cl. A01M 29/30

(52) U.S. Cl. CPC A01M 29/30

(57) ABSTRACT

An apparatus may incorporate a wire brush or insert that may be mounted within or approximate to an opening. The steel wool apparatus can fill an opening and turn mice or other rodents away.

### CROSS-REFERENCE TO RELATED APPLICATIONS

This application claims the benefit of U.S. Provisional Patent Application No. 62/525,840, filed on Jun. 28, 2017, entitled “Wire Brush Pest Control Apparatus,” the contents of which are hereby incorporated by reference herein.

### BACKGROUND

Rodents, such as mice and rats, are typically considered to be pests by homeowners, shopkeepers, and the like because they tend to devour food stores, spread disease, soil dwellings, storage and production facilities, and degrade fixtures and structures through gnawing, scratching, and nesting.

Mice can enter a structure through a hole as small as a one-fourth of an inch in diameter and when inside, they create havoc for the property owner. Mice can enter through slight openings in French double doors, regular exterior doors, garage doors, or the like entry ways. They can introduce ticks, mites, fleas and more pests into the home. Mice may carry and spread diseases like salmonella, hantavirus, bubonic plague, and more. A single female mouse can mother as many as 150 offspring in their short 5 month lifespan and generally a single mouse can produce 40-100 droppings per day.

Some rodent infestations may be dealt with through traditional pest control systems that include distribution of poisoned bait or mechanical rodent traps, such as glue boards or snap mouse traps. There are multiple issues with these traditional pest control systems. Poisoned baits and snap mouse traps may be dangerous for a home with small children or pets. In addition, poison requires seek and search when you detect an odor of a dead rodent that may have died within the walls of a structure. While glue boards may become ineffective in cold temperatures, if the rodent itself is oily or greasy, or if dust coats the glue. Furthermore, a significant number of pest control systems require continual maintenance or replacement and are designed to capture pests (e.g., mice) after they have already entered the home.

### SUMMARY

If mice can get their skull through an opening, they can get their body through, because they have the ability to turn their body into a pencil or less. Mice also gnaw through materials. But mice loathe steel wire, steel wool, or the like. Disclosed herein are apparatuses for deterring rodents, such as mice, from a structure. An apparatus incorporates a wire brush or insert (e.g., steel wire, steel wool, or the like) that may be mounted within or approximate to an opening. The apparatus may be called hereinafter a wire bristle pest control apparatus, in which the wire bristle portion may fill an opening and turn mice and other rodents away.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

A more detailed understanding may be had from the following description, given by way of example in conjunction with the accompanying drawings wherein:

FIG. 1A is an exemplary illustration of an upper view of a wire bristle pest control apparatus;

FIG. 1B is an exemplary illustration of a perspective view and installation of a wire bristle pest control apparatus of FIG. 1A;

FIG. 1C is an exemplary illustration of a rear perspective view of a wire bristle pest control apparatus;

FIG. 2A is an exemplary illustration of an perspective view of a (Steel Wool) wire bristle pest control apparatus;

FIG. 2B is an exemplary illustration of a perspective view and installation of a (Steel Wool) wire bristle pest control apparatus;

FIG. 2C illustrates an exemplary perspective view showing a substantial amount of bristle carrier member and (Steel Wool) bristles;

FIG. 3A is an exemplary illustration of an upper view of a wire bristle pest control apparatus;

FIG. 3B is an exemplary illustration of a perspective view and installation of a wire bristle pest control apparatus of FIG. 3A;

FIG. 4A is an exemplary illustration of a perspective view of a (Steel Wool) wire bristle pest control apparatus;

FIG. 4B is an exemplary illustration of a perspective view and installation of a (Steel Wool) wire bristle pest control apparatus

FIG. 4C illustrates an exemplary perspective view showing a substantial amount of bristle carrier member and (Steel Wool) bristles;

FIG. 5A is an exemplary illustration of a perspective bottom view of a wire bristle pest control apparatus; and

FIG. 5B is an exemplary illustration of a perspective top view and installation of a wire bristle pest control apparatus of FIG. 5A; and

FIG. 5C is an exemplary illustration of separated parts of a wire bristle pest control apparatus.

### DETAILED DESCRIPTION OF ILLUSTRATIVE EMBODIMENTS

If mice can get their skull through an opening, they can get their body through, because they have the ability to turn their body into a pencil or less. Mice also gnaw through materials. But mice cannot stand steel bristles or the like. Disclosed herein are apparatuses for deterring rodents, such as mice, from a structure. An apparatus (also referred to herein as a wire bristle pest control apparatus) incorporates a wire brush or insert that may be mounted within or approximate to an opening. The apparatus fills an opening with an abrasive material that turn mice or other rodents away. Mice and the like rodents dislike abrasive materials. Contemplated herein is the use of steel wool, wire brushes, or the like materials that may be made of bundles of sharp-edged strips that are particularly abrasive.

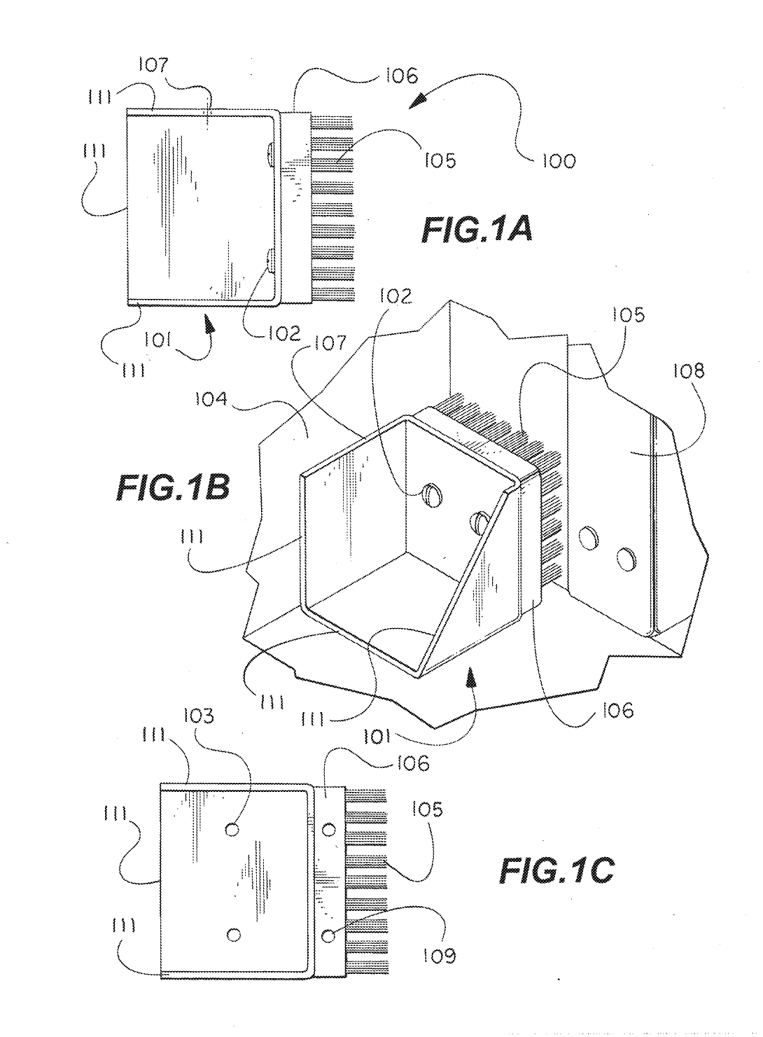

FIG. 1A is an exemplary illustration of an upper view of a wire bristle pest control apparatus. As shown in FIG. 1A, wire bristle pest control apparatus 100 includes base 101, bristle carrier member 106, and bristles 105. Base 101 includes panel 111 which may include hole 107 and hole 102. Hole 107 may be used to insert a screw, nail, or other affixer to secure base 101 onto surfaces such as a wall, floor, or the like. There may be one or more holes 107 that may be located on a horizontal or vertical panel 111 of base 101. Hole 102 may be used to insert a screw, nail, or other affixer to secure base 101 to bristle carrier member 106. Base 101 may be affixed to bristle carrier member 106 in a plurality of different ways that may include adhesive (e.g., glue), clamps, snap and lock apparatuses, or wire, among other things via panel 111. It is contemplated herein that base 101 and bristle carrier member 106 may be combined into a single molded piece. Bristles 105 are preferably made of steel, copper, or the like, but may be made of any material that pokes rodents as disclosed herein and preferably not easily gnawed down by a rodent.

Use of a separate base 101 and bristle carrier member 106 may allow for appropriately adjustable configurations of wire bristle pest control apparatus 100. For example, a first base 101 may be substituted for a second base 101 in order to assist in positioning of wire bristle pest control apparatus 100 on a wall or floor that is more suitable for the second base 101 than the first base 101. In another example, bristle carrier member 106 (with bristles 105) may be substituted for another (e.g., slimmer, taller, or wider) bristle carrier member 106 (with bristles 105) to better fit an opening size or type of rodent. In another example, bristle carrier member 106 (with bristles 105) may be affixed directly to a wall. As shown in FIG. 1C, there may be holes 103 or holes 109 that may be used to insert affixers through bristle carrier member 106 to a wall (e.g., wall 104 in FIG. 1B). It is contemplated that there may be holes (e.g., for screw inserts or snap and lock, etc.) on any edge of bristle carrier member to allow for a connection to different base 101 shapes. In this example in FIG. 1C, bristles 105 may face away (substantially perpendicular) from a wall or substantially parallel to a wall (or other structure, such as a door), but preferably away from the inside of the structure. Further considerations about the adjustable configurations of a wire bristle pest control apparatus is disclosed herein.

FIG. 1B is an exemplary illustration of a perspective view and installation of a wire bristle pest control apparatus. As shown in FIG. 1B, base 101 may have its vertical panel 111 adjacent to wall 104 (e.g., a garage door wall). A screw (not shown) may be placed in hole 107 to secure base 101. It is preferred that wire bristle pest control apparatus 100 be secured so that it remains effective. If not secured, any number of events (e.g., a person accidently hitting pest control apparatus 100) may move wire bristle pest control apparatus 100 to a position where it allows a rodent to enter and thus being ineffective. Base 101 may have another vertical panel 111 adjacent to garage door track 108 and may be positioned in a manner that allows much less than one-fourth inch opening between wall 104 and garage door track 108. It is contemplated that wire bristle pest control apparatus 100 is usually placed near ground level and extend between 3-12 inches in height. Base 101 may have a plurality of panels (e.g., three vertical panels 111 and one horizontal panel) connected with each other. One of the vertical panels of base 101 may be connected with a bristle carrier member 106. The bristle carrier member 106 may have a panel that affixes to panel 111. The panel of bristle carrier member 106 may have attached bristles. The attached bristles may be in the form of brush or a steel wool pad that is affixed to the bristle carrier member 106.

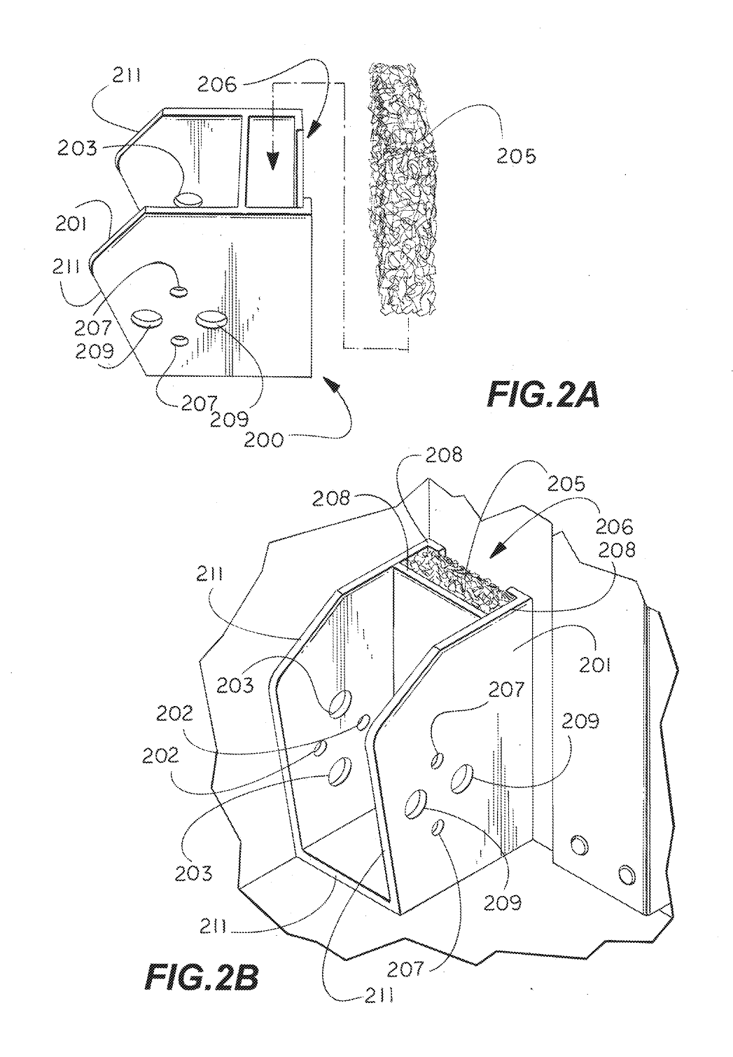

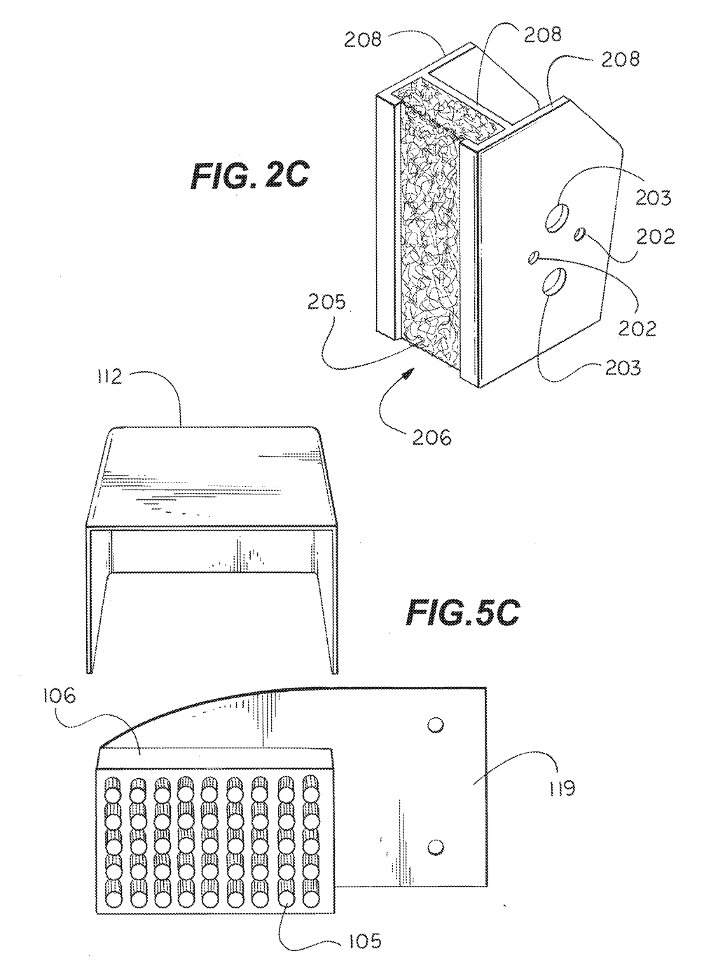

FIG. 2A is an exemplary illustration of an perspective view of a (Steel Wool) wire bristle pest control apparatus. As shown in FIG. 2A, wire bristle pest control apparatus 200 includes base 201, bristle carrier member 206, and bristles 205 (e.g., steel wool pad). Base 201 includes panel 211 that may be affixed to a structure (e.g., wall, door, or window). Panel 211 may include hole 202, hole, 203, hole 207, or hole 209. Hole 207 and hole 202 may be used to insert a screw, nail, or other affixer to secure panel 211 of base 201 onto surfaces such as a wall, floor, or the like. There may be one or more holes 207 that may be located on a horizontal or vertical panel 211 of base 201. Hole 209 may be larger than hole 202 so that it able to fit a standard tool such as a screwdriver. Hole 209 may be across from smaller hole 202 and allows for easier attachment of panel 211. Bristle carrier member 206 may form a recess using panels 208 that may help secure material, such as bristles 205. In the example, bristle 205 is an insert that can be cut to a similar shape of the recess of bristle carrier member 206 and subsequently inserted into bristle carrier member 206, as shown. Bristles 205 are preferably made of steel, copper, or the like, but may be made of any material that pokes rodents as disclosed herein and preferably not easily gnawed down by a rodent. A new bristle carrier member 206 may slide out to be replaced or cleaned. Although not shown, it is contemplated that there may be multiple bristle carrier members and combination of forms (e.g., 206 or 106).

FIG. 2B is an exemplary illustration of a perspective view and installation of a wire bristle pest control apparatus. As shown in FIG. 2B, base 201 may have its vertical panel adjacent to wall 204 (e.g., a garage door wall). A screw (not shown) may be placed in hole 202 to secure panel 211 of base 201. It is preferred that wire bristle pest control apparatus 200 be secured so that it remains effective. If not secured, any number of events (e.g., a person accidently hitting pest control apparatus 200) may move wire bristle pest control apparatus 200 to a position where it allows a rodent to enter and thus being ineffective. Base 201 may have another vertical panel 111 adjacent to garage door track 108 and may be positioned in a manner that allows much less than one-fourth inch opening between wall 204 and garage door track 108. It is contemplated that wire bristle pest control apparatus 200 is usually placed near ground level and extend between 3-12 inches in height, in which 12 inches is generally the height a mouse may jump or attempt to crawl up a wall. FIG. 2C illustrates an exemplary perspective view showing a substantial amount of bristle carrier member 206 and bristles 205. Base 201 may have a plurality of panels (e.g., two vertical panels 211 and one horizontal panel) connected with each other. One of the vertical panels of base 201 and bristle carrier member 206 may share a panel 208. Base 201 may be connected with bristle carrier member 206 in one molded piece. Bristle carrier member 206 may include four vertical panels (e.g., three panels 208 and one or more panels 218). Bristle carrier member 206 may form a recess to insert bristles 205 (e.g., a steel wool pad or brush insert). Bristles 205 may be in the form of a brush or pad.

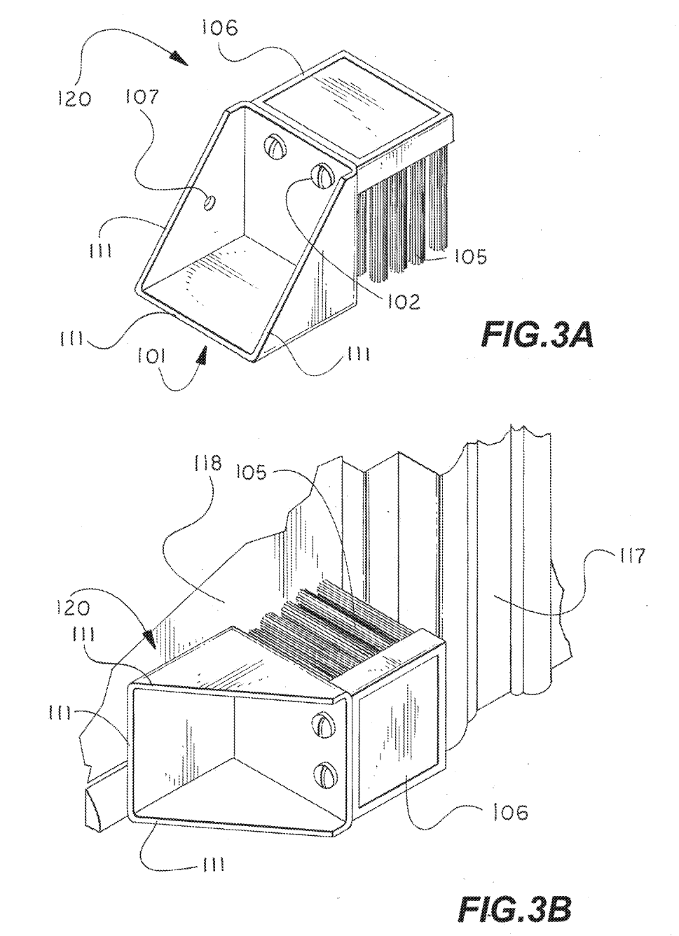

FIG. 3A is an exemplary illustration of an upper view of a wire bristle pest control apparatus. As shown in FIG. 3A, wire bristle pest control apparatus 120 includes base 101, bristle carrier member 106, and bristles 105. Base 101 include holes 107 and holes 102. It is contemplated herein that there may be multiple holes on panel 111 of base 101, which are not necessarily shown. Holes 107 may be used to insert a screw, nail, or other affixer to secure base 101 onto surfaces such as a wall, floor, door, or the like. There may be one or more holes 107 that may be located on a horizontal or vertical panel 111 of base 101. Holes 102 may be used to insert a screw, nail, or other affixer to secure base 101 to bristle carrier member 106. Base 101 may be affixed to bristle carrier member 106 in a plurality of different ways that may include adhesive (e.g., glue), clamps, or wire, among other things. It is contemplated herein that base 101 and bristle carrier member 106 may be combined into a single molded piece. As shown in FIG. 3A, bristle carrier member 106 (with bristles 105) is attached so that an affixer is entering through a hole located on the side of bristle carrier member 106, which is similar to holes 109 as shown in FIG. 1C.

FIG. 3B is an exemplary illustration of a perspective view and installation of a wire bristle pest control apparatus. As shown in FIG. 3B, base 101 may have its panel 111 adjacent (and attached) to door 118 (e.g., inside a structure). A screw (not shown) may be placed in hole 107 to secure base 101. It is preferred that wire bristle pest control apparatus 120 be secured so that it remains effective. Base 101 may have another panel 111 adjacent to door frame 117 and may be positioned in a manner that blocks an opening between door 118 and door frame 117. It is contemplated that wire bristle pest control apparatus 120 is usually placed near ground level and extend between 3-12 inches in height. As shown in FIG. 3B, bristles 105 are substantially perpendicular to door 118 and rest on door 118. This configuration of wire bristle pest control apparatus 120 may minimize accidental pricks to inside animals, persons, furniture, or the like because it faces towards the door. Also having wire bristle pest control apparatus 120 attached to door 118 as shown reduces the likelihood of tripping over wire bristle pest control apparatus 120 or pricks by bristles 105. It is contemplated herein that wire bristle pest control apparatus 120 may be attached to wall 117 in which bristles 105 face door 118, but this is not the preferred configuration because it may be a tripping or pricking hazard as it remains static. Although the configuration of wire bristle pest control apparatus 120 as shown in FIG. 3B has a preferred use inside, it also may be used outside, wherein bristles 105 are preferably facing the opposite direction of the inside of the structure in order to turn away rodents (e.g. mice) from entry. When installing wire bristle pest control apparatus 120 to a door frame, the direction in which the door opens should be considered so not to accidently keep an adjacent door from opening.

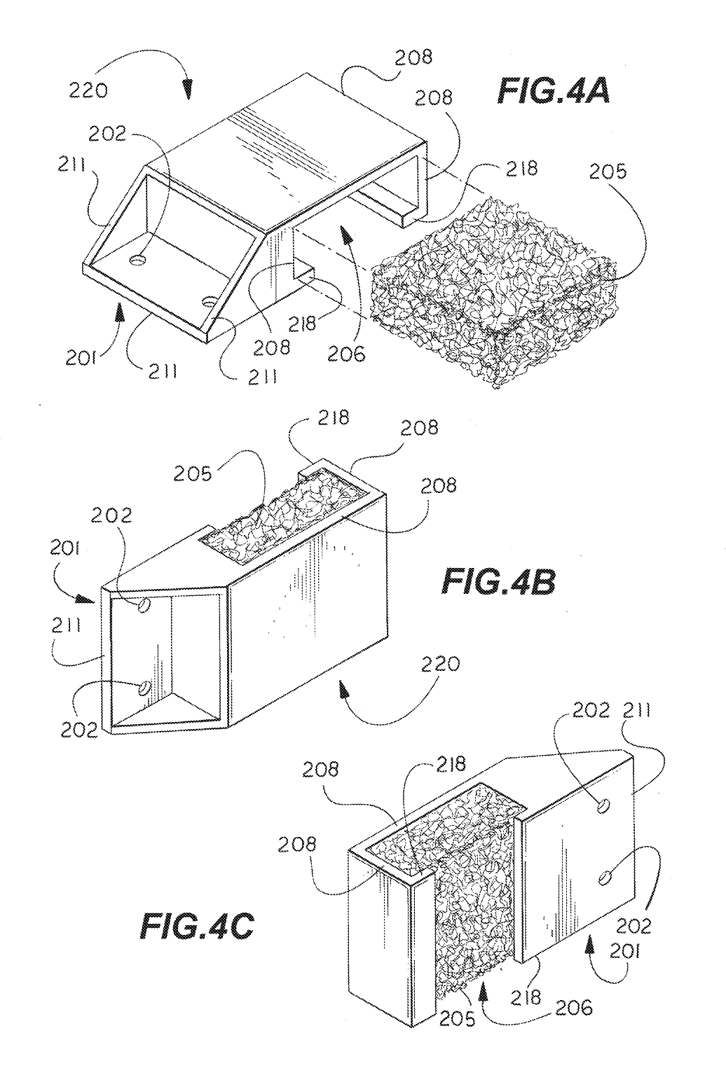

FIG. 4A is an exemplary illustration of a perspective view of a wire bristle pest control apparatus. As shown in FIG. 4A, wire bristle pest control apparatus 220 includes base 201, bristle carrier member 206, and bristles 205. Base 201 may include holes 202. It is contemplated herein that there may be multiple holes on panel 211 of base 201, which are not necessarily shown. Holes 202 may be used to insert a screw, nail, or other affixer to secure base 201 onto surfaces such as a wall, floor, door, or the like. There may be one or more holes 202 that may be located on a horizontal or vertical panel 211 of base 201. Bristles 205 may be inserted in or attached to bristle carrier member 206 in a plurality of different ways that may include adhesive (e.g., glue), clamps, or wire, among other things. As shown, base 201 and bristle carrier member 206 is a single molded piece. Similar to FIG. 2A, bristle carrier member may form a recess with panel 208. There may be a short panel 218 that helps secure bristle 205, but leaves an area for bristles 205 to be exposed to any hole when installed.

FIG. 4B is an exemplary illustration of a perspective view and installation of a wire bristle pest control apparatus. As shown in FIG. 4B, base 201 may have its panel 211 adjacent (and attached) to door 218 (e.g., inside a structure). A screw (not shown) may be placed in hole 202 to secure base 201. It is preferred that wire bristle pest control apparatus 220 be secured so that it remains effective. Base 201 may have another panel 211 adjacent to door frame 217 and may be positioned in a manner that blocks an opening between door 118 and door frame 117. It is contemplated that wire bristle pest control apparatus 220 is usually placed near ground level and extend between 3-12 inches in height. As shown in FIG. 4B, bristles 205 may rest on door 218. This configuration of wire bristle pest control apparatus 220 may minimize accidental pricks to inside animals, persons, furniture, or the like because it faces towards the door. Also having wire bristle pest control apparatus 220 attached to door 118 as shown reduces the likelihood of tripping over wire bristle pest control apparatus 220 or pricks by bristles 205. It is contemplated herein that wire bristle pest control apparatus 220 may be attached to wall 117 in which bristles 205 face door 218, but this is not the preferred configuration because it may be a tripping or pricking hazard as it remains static. Note that wire bristle pest control apparatus 220 may be hinged otherwise bendable to move in the direction of any force against it; therefore reducing the likelihood of damage to person or the wire bristle pest control apparatus 220. Although the configuration of wire bristle pest control apparatus 220 as shown in FIG. 4B has a preferred use inside, it also may be used outside, wherein bristles 205 are preferably facing the opposite direction of the inside of the structure in order to turn away rodents (e.g. mice) from entry. When installing wire bristle pest control apparatus 220 to a door frame, the direction in which the door opens should be considered so not to accidently keep an adjacent door from opening. But, again, it is contemplated that a hinged function may allow for the wire bristle pest control apparatus 220 to appropriately bend to allow access in the aforementioned situations. FIG. 4C illustrates an exemplary perspective view showing a substantial amount of bristle carrier member 206 and bristles 205.

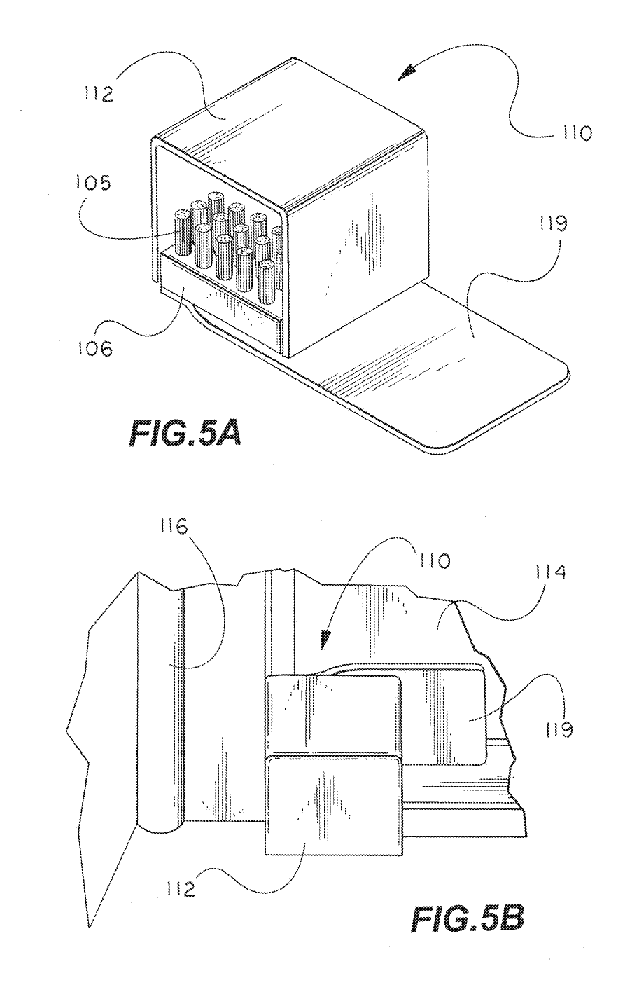

FIG. 5A is an exemplary illustration of a perspective bottom view of a wire bristle pest control apparatus. As shown in FIG. 5A, wire bristle pest control apparatus 110 includes base 112, bristle carrier member 106, and bristles 105. In FIG. 5A, base 101 includes holes (not shown in FIG. 5A, but similar in concept to FIG. 1A, FIG. 2A, FIG. 3A, and FIG. 4A) which may be used to insert a screw, nail, or other affixer to secure base 112 onto surfaces such as a wall, floor, door, or the like. Base 112 may be affixed to bristle carrier member 106 in a plurality of different ways that may include glue, clamps, or wire, among other things. It is contemplated herein that base 112 and bristle carrier member 106 may be combined into a single molded piece. In FIG. 5A, bristle carrier member 106 (with bristles 105) may be attached to base 112 by an affixer connected with the sides (e.g., holes 109 of 1C) or back (e.g., holes 103 of FIG. 1C) of bristle carrier member 106.

FIG. 5B is an exemplary illustration of a perspective top view and installation of a wire bristle pest control apparatus. As shown in FIG. 5B, base 112 may have its tab 119 adjacent (and attached) to door 114 (e.g., outside a structure). An affixer may be used to secure base 112 to door 114. The affixed wire bristle pest control apparatus 110 covers any opening between door frame 116 and door 114 that a rodent may attempt to enter. Wire bristle pest control apparatus 110 remains attached to door 114 when it opens or closes. It is contemplated that wire bristle pest control apparatus 120 is usually placed near ground level. As shown in FIG. 3B, bristles 105 are substantially perpendicular to door 118 and within base 112. Base 112 may be considered housing for bristle carrier member 106 that may be of a dome shape or any other shape that may allow a rodent to enter it. This configuration of wire bristle pest control apparatus 110 may minimize accidental pricks to larger outside animals, persons, furniture, or the like because bristles 105 is enclosed by base 112. Also having wire bristle pest control apparatus 110 attached to door 114 as shown reduces the likelihood of tripping over wire bristle pest control apparatus 110 or pricks by bristles 105. Although the configuration of wire bristle pest control apparatus 110 as shown in FIG. 5B has a preferred use outside, it also may be used inside, wherein bristles 105 are preferably facing the opposite direction of the inside of the structure in order to turn away rodents (e.g. mice) from entry. Base 112 may be shaped and decorated (e.g., painted) in a manner that is aesthetically pleasing and is not easily noticeable. Bristle carrier member 106 may be adjusted (not shown) so that bristles 105 may point in different angles (e.g., 30 degrees, 60 degrees, 90 degrees, etc.).

FIG. 5C is an exemplary illustration of separated parts of a wire bristle pest control apparatus. As shown in FIG. 5C, base 112 may be a removable covering to bristle carrier member. Base 112 may snap (or screw) on or off bristle carrier member 106. In an example, bristle carrier member 106 may be attached to tab 119. Tab 119 may be screwed (or otherwise attached) onto door 114 and may be somewhat flexible. All or some of bristle carrier member 106, base 112, bristles 105, or tab 119 may be combined into a single molded piece for the combination (e.g., bristle carrier member 106 and tab 119). An example single molded piece may be the pest control apparatus of FIG. 4A-FIG. 4C, in which panel 211 is configured so that it attaches to a door and bristle carrier member 206 is facing away from the door. There may be a cover (e.g., similar to base 112) that goes over bristle carrier member 206.

Wire bristle pest control apparatus 110 (or 100 or 120 hereinafter) may be integrated with sensors (e.g., camera, motion sensor, or the like) to record attempted intrusions by a rodent. This recordation of intrusions may help determine the efficacy of wire bristle pest control apparatus 110 (or 100 or 120) and may alert a manager of the structure that wire bristle pest control apparatus 110 (or 100 or 120). Based on the alert the manager of the structure may determine other actions to help deter rodents (e.g., properly disposing of garbage around the property). In addition, it is contemplate herein that instead of bristles 15 there may be steel wool used for wire bristle pest control apparatus 110 (or 100 or 120). In an example, steel wool may be inserted base 112 in addition to or instead of bristles 105. As disclosed herein, bristles 105 prick rodents (e.g., mice) in a way that is very uncomfortable and repels the rodents; thus keeping them outside the structure.

A contemplated base (e.g., base 101 or 112 hereinafter) may be cylindrical or tubular (including oval or elliptical), triangular, square, polygonal, wider at one end than the other, and may be designed in any shape allowing for different securing options to a part of a structure (e.g., a wall of a house). For example, base 101 may have a continuously curved convex region and radially smaller end regions. A contemplated base 101 may comprise or be covered with a grippable material, wherein the grippable material allows for the base 101 to be substantially secure against the force of a rodent.

In a contemplated embodiment, the wire bristle pest control apparatus may comprise the same or similar material for all of the components, including base 101, bristle carrier member 106, and the plurality of bristles. But in many configurations of wire bristle pest control apparatus 110, the material used for base 101 and bristle carrier member 106 may be hard or solid and the material used for the bristles 105 may be metal (e.g., steel or copper). In the latter case, it should be understood that the some of the materials may be injection molded or otherwise molded, so that they keep their contemplated form—either solid/hard. A contemplated material for base 101 may comprise plastic, polymer material, composite material, graphite material, a metal-based material, a sustainable or “green” material, such as bamboo or a combination thereof.

A contemplated wire bristle pest control apparatus 110 may be manufactured with different combinations of materials, lengths, diameters and in different colors. Base 101 may be manufactured in any desired shape and does not necessarily have to match the shape of bristle carrier member 106. For example, a contemplated base 101 may have a circular cross-sectional shape, an elliptical cross-sectional shape, a triangular cross-sectional shape, a square cross-sectional shape, a trapezoidal cross-sectional shape or a polygonal cross-sectional shape.

In summary, disclosed herein is an apparatus that may be used for pest control. The apparatus may include a base, a bristle carrier member connected with the base, and a plurality of bristles held by the bristle carrier member. The plurality of bristles may be made of steel, copper, or any bundle of abrasive material that is particularly disliked by rodents. An apparatus may include a base; a plurality of bristle carrier members connected with the base; and one or more bristle inserts or brushes held by the plurality of bristle carrier members. An apparatus may include a housing that comprises a base and a bristle carrier member. The base may include an attachment or a hole to insert an attachment for a structure (e.g., wall, door, or window). The attachment may be an adhesive, hook-and-loop fastener, an affixer, or the like. A method for securing the apparatus used for pest control near an opening is contemplated herein.

Thus, specific applications of wire bristle pest control apparatus 110 have been disclosed. It should be apparent, many more modifications besides those already described are possible without departing from the inventive concepts herein. It is contemplated that the different elements of the disclosed forms of wire bristle pest control apparatus disclosed herein (e.g., FIG. 1A-FIG. 5B) may be mixed and matched. The inventive subject matter, therefore, is not to be restricted except in the spirit of the disclosure herein. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. The use of the term “or” herein is used in an inclusive manner unless otherwise disclosed.

What is claimed:

1. A pest control apparatus, comprising:
a base,
a bristle carrier member connected with the base, and
bristles.

2. The apparatus of claim 1, wherein the bristles are a bundle of sharp-edged strips.

3. The apparatus of claim 1, wherein the base comprises a panel for attachment to a structure.

4. The apparatus of claim 1, wherein the bases comprises a panel for attachment to a structure, the panel for attachment the structure comprises an adhesive.

5. The apparatus of claim 1, wherein the bases comprises a panel for attachment to a structure, the panel for attachment to the structure having an opening for an affixer.

6. The apparatus of claim 1, wherein the base and the bristle carrier member is a single molded piece.

7. The apparatus of claim 1, wherein the bristle carrier member having a recess configured for holding the bristles.

8. The apparatus of claim 1, wherein the bristles are in the form of a brush.

9. A pest control apparatus, comprising:
a base, and
a bristle carrier member connected with the base.

10. The apparatus of claim 1, wherein the bristle carrier member having a recess configured for holding material, the material comprising bristles.

11. The apparatus of claim 1, wherein the bases comprises a panel for attachment to a structure.

12. The apparatus of claim 1, wherein the bases comprises a panel for attachment to a structure, the panel for attachment to the structure comprises an adhesive.

13. The apparatus of claim 1, wherein the bases comprises a panel for attachment to a structure, the panel for attachment to a structure having an opening for an affixer.

14. A pest control apparatus comprising:
a dome-shaped housing, wherein the dome-shaped housing comprises:
a base, wherein the base comprises a panel for attachment to a structure, wherein the structure comprises a wall, door, or a window; and
a bristle carrier member having a recess configured for holding material, the material comprising bristles.

15. The apparatus of claim 14, wherein the bristles are a bundle of sharp-edged strips.

16. The apparatus of claim 14, wherein the panel for attachment the structure comprises an adhesive.

17. The apparatus of claim 14, wherein the panel for attachment to the structure having an opening for an affixer.

18. The apparatus of claim 14, wherein the bristle carrier member having a recess configured for holding the bristles.

19. The apparatus of claim 14, wherein the bristles are in the form of a brush

20. The apparatus of claim 14, wherein the bristles are in the form of a brush and the bristles are substantially parallel to the panel for attachment to the structure.
